(19) United States
(12) Patent Application Publication
(10) Pub. No.: US 2022/0346593 A1
(43) Pub. Date: Nov. 3, 2022

(54) WARMER PLATE AND KIT FOR WARMING FOOD

(71) Applicant: Audrey Hubbard, Brooklyn, NY (US)

(72) Inventor: Audrey Hubbard, Brooklyn, NY (US)

(21) Appl. No.: 17/689,040

(22) Filed: Mar. 8, 2022

Related U.S. Application Data
(60) Provisional application No. 63/181,552, filed on Apr. 29, 2021.

(51) Int. Cl. A47J 36/24; A47J 27/00

(52) U.S. Cl. CPC A47J 36/2483; A47J 27/002

(57) ABSTRACT

The present invention relates to a multipurpose heating plate and a system designed to maintain food items at an optimal or elevated temperature for consumption. More specifically, the plate includes a heating element embedded within the plate, and disposed between a top surface and a bottom surface. The heating element radiates heat to maintain the warmth of the food placed on the top surface for a prolonged period of time to avoid deterioration of the food. The plate can include an insulating cover comprising silicone or rubber. A storage and charging rack includes a plurality of slots for storing the warmer plates. Each slot includes a charging slot for charging the heating element. The warmer plate also includes a charging port for engaging with the charging slot, thereby enabling the heating element to charge.

### CROSS-REFERENCE TO RELATED APPLICATION

The present application claims priority to, and the benefit of, U.S. Provisional Application No. 63/181,552, which was filed on Apr. 29, 2021 and is incorporated herein by reference in its entirety.

### FIELD OF THE INVENTION

The present invention relates generally to multipurpose food warming plate system. More specifically, the present invention relates to a multipurpose food warming plate system that provides optimal temperature to food items while being served and eaten. The multipurpose food warming plate system includes at least a warmer plate and storage and charging rack. The warmer plate includes an embedded heating element for warming food items placed on top surface of the plate. The storage and charging rack include a plurality of slots for storing warmer plates and charging the heating element of the warmer plates. Accordingly, the present disclosure makes specific reference thereto. Nonetheless, it is to be appreciated that aspects of the present invention are also equally applicable to other like applications, devices, and methods of manufacture.

### BACKGROUND OF THE INVENTION

By way of background, plates, and trays, are used for serving and eating food items. Generally, a food item that is meant to be served hot may get cold quickly when placed on a conventional plate or a tray. A serving person may have to rush to serve the individuals who order such items to time. A person may also have to rush through a meal to prevent the food item from getting cold. In some cases, when the food item gets cold, individuals may find it unappetizing, and the food may get wasted.

Also, the optimal temperature of a food item may not be maintained when a user who is having the food item may get on a call or engage in a conversation with someone. As a result, individuals may have to rush their eating, and may not eat at a leisurely pace. In such cases, some of the food items may be wasted.

Further, hot food items emit a great aroma and texture, thereby enabling individuals to enjoy food with pleasure. Maintaining an elevated temperature of hot food items is also desired by chefs when serving food to customers for optimal taste and enjoyment of food. Physical fire or heat may not always be safe for both the quality of the food and for individuals preparing and serving the food. Thus, a system and apparatus is desired that can maintain the warmth of food items when served and while being eaten, thereby enabling individuals to eat at a leisurely pace.

Therefore, there exists a long felt need in the art for a food warming device and system that offers a way for individuals to eat at a leisurely pace, without food becoming cold and unappetizing. There is also a long felt need in the art for a food warming device and system that provides optimal temperature to keep food warm when served or eaten. Additionally, there is a long felt need in the art for a food warming device and system that allows users to carry and eat hot food without worry of burns or other injuries. Further, there is a long felt need in the art for a food warming device and system that does not cook the food, but maintains the food at an elevated temperature. Moreover, there is a long felt need in the art for a food warming device and system that can be used by novice users and does not require professional intervention. Finally, there is a long felt need in the art for a food warming device and system that keeps food at an optimal and/or elevated temperature for leisure and delayed consumption. The warming device can be used for breakfast, lunch, dinner, snacks and other meals.

The subject matter disclosed and claimed herein, in one embodiment thereof, comprises a food warming plate. The food warming plate maintains an elevated temperature (i.e. higher than ambient temperature) of food items placed on the plate at an optimal or preferred temperature for consumption. More specifically, the plate includes a heat-conducting top food contact surface, a rim insulated partially or wholly by an insulating cover and an insulating bottom surface. A heating element embedded within the plate and disposed between the top surface and the bottom surface radiates heat to maintain warmth of the food placed on the top surface for a prolonged period of time. The warming plate further includes a charging port for recharging the heating element and a push button (i.e. an actuation button) for activating or deactivating the heating element. The warming plate can be used with a storage and charging rack designed to store and charge a plurality of food warming plates. Both the food warming plate and the storage and charging rack form the food warming system of the present invention.

In this manner, the food warming plate and the food warming system of the present invention accomplishes all of the forgoing objectives and provides a relatively easy and convenient device and system to allow users to maintain warmth of food items. The system features an integrated heating element embedded in the plate and enables users to charge the plates in a plug-in storage rack that can house several plates simultaneously. The system can be used for breakfast, lunch, dinner, snacks and other meals used to keep food at an optimal or elevated temperature for lei surely or delayed consumption.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a multipurpose heating plate. The multipurpose heating plate is designed to maintain an elevated temperature of food items for consumption. More specifically, the plate further comprises a conducting top surface configured as a food contact surface, a rim insulated partially or wholly by an insulating cover, an insulating bottom surface and a heating element embedded within the plate and disposed between the top surface and the bottom surface. The heating element radiates heat to maintain the warmth of the food placed on the top surface for a prolonged period of time to avoid deterioration of the food. The heating plate further includes a charging port for recharging the heating element and a push button for activating or deactivating the heating element.

In yet another embodiment of the present invention, the heating element can be one or more of a heating coil, an electrical resistance plate or sheathed electric heating rods. The insulating cover can be of silicone or rubber.

In a further embodiment of the present invention, a food warmer kit for keeping food items placed on a warmer plate warm for a prolonged time is disclosed. The food warmer kit includes: at least one warmer plate; the warmer plate having an embedded heating element for radiating heat for warming food items placed on a top surface of the warmer plate; a storage and charging rack having a plurality of slots for storing the at least one warmer plate; and, each slot having a charging slot for charging the heating element. The warmer plate also includes a charging port for engaging with the charging slot, thereby enabling the heating element to charge.

In yet another embodiment of the present invention, the storage and charging rack includes a power cord for providing an electrical supply to the charging slot. Also, a built-in battery can be used for providing power to the charging slot.

In yet another embodiment of the present invention, a storage and charging rack for storing and charging food warmer plates is disclosed. The storage and charging rack includes: a plurality of separate slots for accommodating food warmer plates, wherein each slot accommodates a single warmer plate; each slot having a charging slot for charging a heating element of the food warmer plate; a knob control for adjusting the heating level of the plates; a plurality of individual control buttons for activating and deactivating individual charging slots; an integrated battery for providing power to the charging slots; and an electrical cord for providing electrical supply to the charging slots.

In yet another embodiment of the present invention, the charging slots are actuated when the charging port of the warmer plates are engaged with the charging slots of the rack.

Advantageously, the integrated heating element embedded between the top surface and bottom surface of the plate can be charged and activated prior to a meal. The plate includes a rubber base and an insulated rim, which ensures that users can carry and handle the plate without worry of burns or other injuries. The plates can be accommodated in a plug-in storage rack that can house several plates for charging.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a multipurpose plate with integrated heating element of the present invention in accordance with the disclosed architecture;

FIG. 2 illustrates a perspective view showing one potential embodiment of a storage and charging rack for storing and charging multipurpose plate of the present invention in accordance with the disclosed architecture;

FIG. 3 illustrates a perspective view showing a plurality of multipurpose plates stored in the storage and charging rack in accordance with the disclosed architecture;

FIG. 4 illustrates a plan view showing a user carrying the multipurpose plate by holding the rubber base in accordance with the disclosed architecture;

FIG. 5 illustrates a perspective view of one potential embodiment showing a food warmer kit of the present invention in accordance with the disclosed architecture;

FIG. 6 illustrates a perspective view showing another embodiment of a warmer plate of the present invention in accordance with the disclosed architecture; and

FIG. 7 illustrates a bottom plan view showing the warmer plate of FIG. 6 in accordance with the disclosed architecture.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a food warming device and system that offers a way for individuals to eat at a leisurely pace without food becoming cold and unappetizing. There is also a long felt need in the art for a food warming device and system that provides optimal temperature to keep food warm when served or eaten. Additionally, there is a long felt need in the art for a food warming device and system that allows users to carry and eat hot food without worry of burns or other injuries. Further, there is a long felt need in the art for a food warming device and system that does not cook the food, but maintains the food at an elevated temperature. Moreover, there is a long felt need in the art for a food warming device and system that can be used by novice users and does not require professional intervention. Finally, there is a long felt need in the art for a food warming device and system that keeps food at an optimal and/or elevated temperature for leisure and delayed consumption. The warming device can be used for breakfast, lunch, dinner, snacks and other meals.

The present invention, in one exemplary embodiment, includes a food warmer kit for keeping food items placed on a warmer plate heated or warm for a prolonged time. The food warmer kit includes: at least one warmer plate; the warmer plate having an embedded heating element for radiating heat for warming food items placed on a top surface of the warmer plate; a storage and charging rack having a plurality of slots for storing the at least one warmer plate; and, each slot having a charging slot for charging the heating element. The warmer plate also includes a charging port for engaging with the charging slot, thereby enabling the heating element to charge.

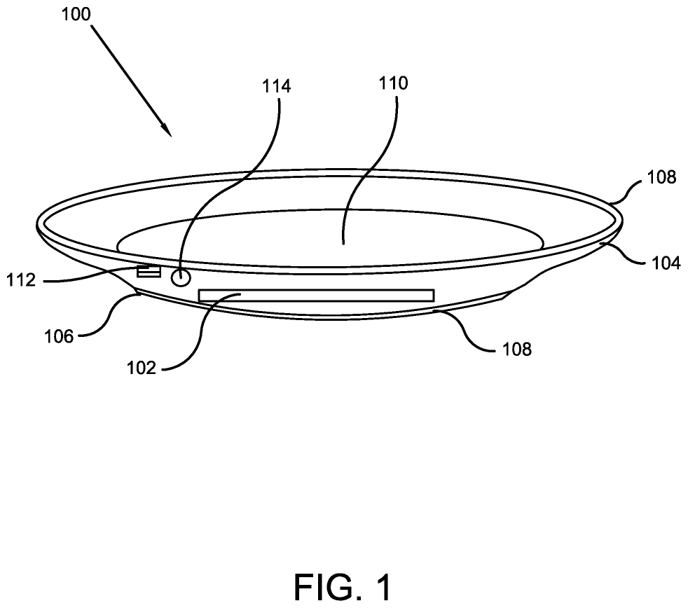

Referring initially to the drawings, FIG. 1 illustrates a perspective view of one potential embodiment of a multipurpose plate with integrated heating element of the present invention in accordance with the disclosed architecture. The multipurpose plate 100, with integrated heating element 102, is designed to keep food at an optimal or elevated temperature for leisurely or delayed consumption and can be used for breakfast, lunch, dinner, snacks and other meals. The multipurpose plate 100 includes a rim 104 and a bottom surface 106. The rim 104 provides a circumferential periphery or area for grasping. The bottom surface 106 can be used for placing the plate 100 on any surface. In the present embodiment, both the rim 104 and the bottom surface 106 include an integrated layer 108 of an insulated material such as rubber or silicone. The insulated layer 108 can alternatively be selectively-detached from the rim 104.

An integrated heating element 102 in the form a heating coil, electrical resistance plate or sheathed electric heating rods is present within the multipurpose plate 100, preferably between the rim 104 and the bottom surface 106. The heating element 102 provides radiating heat to the food items placed on the top surface 110 of the multipurpose plate 100 enabling the food to retain its elevated temperature until consumed. The heating element 102 provides an adequate temperature enabling the food items to remain at a desired temperature for a longer time. Advantageously, the heating element 102 can be disposed above the bottom surface 106 and spaced from the top surface 110 and the rim 104 for providing radiant heating to food placed on the top surface 110. The top surface 110 can be a conducting surface enabling the food items to absorb the heat radiating from the top surface 110.

For enabling the heating element 102 to charge using a storage rack, a charging port 112 can be positioned on the rim 104. The charging port 112 is preferably positioned where the insulating layer 108 is not present. In embodiments where the insulating layer 108 is selectively detachable, the charging port 112 can be present on the portion of the rim 104 which is covered by the insulating layer 108.

A control push button 114 can be disposed on the plate 100 enabling a user to activate the heating element 102 for providing radiating heat to the food items. When the user does not need any heating or may want to stop the heating, the push button 114 can be used for deactivating the heating element 102.

It is to be appreciated that the all the components described above, i.e. charging port 112 and the push button 114, are waterproof and can be covered by a waterproofing and insulating layer, thereby enabling a user to easily wash the multipurpose plate 100 both manually or in a dishwasher. The heating element 102 can be programmed to reach a predeterminable maximum temperature, thereby enabling a food item to retain an elevated temperature as per the desire of the user.

The heating element 102 radiates the heat upwards enabling the rim 104 and the bottom surface 106 to be less hot, thereby enabling a user to easily hold the multipurpose plate 100 without fear of getting burnt. The heating element 102 can be disposed within a portion of the plate 100 or along the complete space between the top surface 110 and the bottom surface 106. The heating element 102 permits the food to retain an elevated temperature and held for extended periods of time without causing the food to deteriorate or decline in temperature. The heating element 102 can be controlled to provide a temperature in the range generally from about 120° F. to about 180° F.

This multipurpose plate 100 is intended to be used to retain an elevated temperature to the food placed thereon, and hold relatively thin foods such as hamburgers, hot dogs, chicken breasts, pizzas, burritos, calzones, rice dishes, etc. in a warm or hot state for a prolonged time period. Since the rim 104 and the bottom surface 106 of the warmer plate 100 are maintained at a low temperature, wherein an individual can touch the same without getting burned, the plate 100 can be used in a home, a store front, a kiosk, etc.

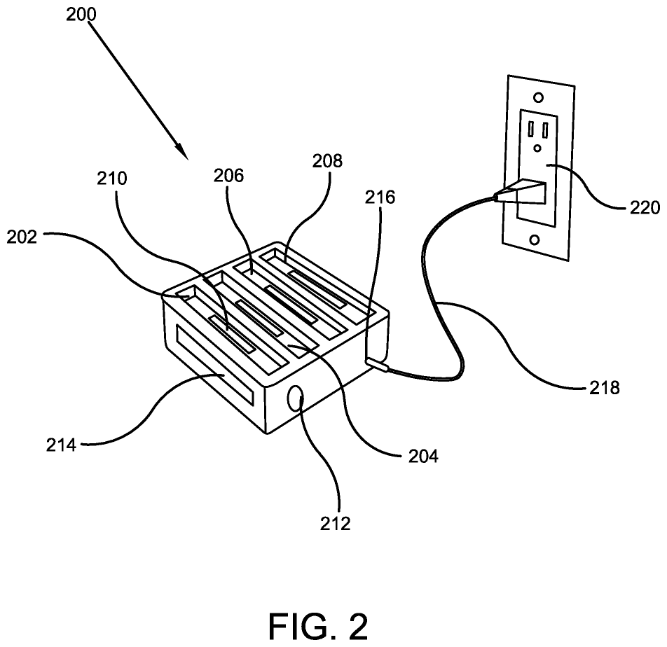

FIG. 2 illustrates a perspective view showing one potential embodiment of a storage and charging rack for storing and charging the multipurpose plates of the present invention in accordance with the disclosed architecture. The storage and charging rack 200 includes a portable charging deck that can be used for storing a plurality of multipurpose plates 100. The rack 200 is commercially available with the multipurpose warmer plates 100, and includes a plurality of slots 202, 204, 206, 208 for storing the plates 100. Each slot can be dimensioned as per the size of the plate 100 and includes a charging slot 210. The charging slot 210 provides electrical energy to the heating element embedded within the multipurpose plate 100 when the charging port of the plate 100 is positioned on the charging slot 210.

Each slot stores the plate 100 in a stable and secure manner and allows a user to easily pick up a fully charged multipurpose plate 100. The storage and charging rack 200 includes a knob control 212 enabling a user to adjust the heating level or temperature of the plate 100. For providing charging, the rack 200 comes with a power cord 218 plugged in to inlet 216 at one end, and plugged in to a conventional electrical power supply 220 at another end. The electric power supply 220 can be a 110V or 220V power supply. In cases where the electric supply 220 is not available, a built-in battery 214 integrated within the rack 200 provides the required power for charging the heating element of the warmer plate 100 through the charging slot 210.

The charging slot 210 can be designed to provide power through one or more of infrared technology, microwave technology or any other mode of wired or wireless charging technology. In one embodiment, the charging slot 210 can be in the form of a coil that can provide heating to the heating element of the plate 100 through induction or radiation. The rack 200 can be constructed with one or more materials selected from a group consisting of a lightweight plastic, a metal, or a wood, and can be insulated and waterproof. The rack 200 can come in various colors and designs and can have a similar appearance as that of the multipurpose plate 100.

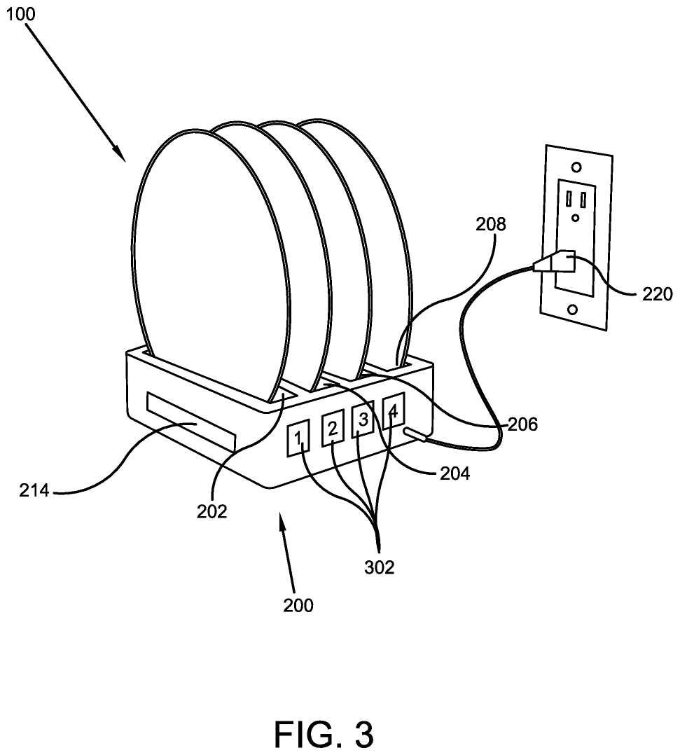

FIG. 3 illustrates a perspective view showing a plurality of multipurpose plates stored in a storage and charging rack 200 in accordance with the disclosed architecture. As shown, one multipurpose plate 100 can be stored in each slot 202, 204, 206, 208 of the rack 200. Each slot of the rack 200 includes enough depth to stabilize and secure the multipurpose plate 100. While a plate 100 is stored in a slot of the rack 200, the heating element of the plate 100 can be charged using the charging slot disposed in the rack 200 as described in FIG. 2. Electrical supply 220 or the built-in battery 214 can be used for providing electrical supply for recharging the heating element of the plate 100.

Additionally, the rack 200 can have individual control buttons 302 enabling charging slots for each slot 202, 204, 206, 208 to be individually controlled. In cases where only a single plate 100 is placed in any of the slots, the charging slots of the other slots can be turned off using the individual control buttons 302.

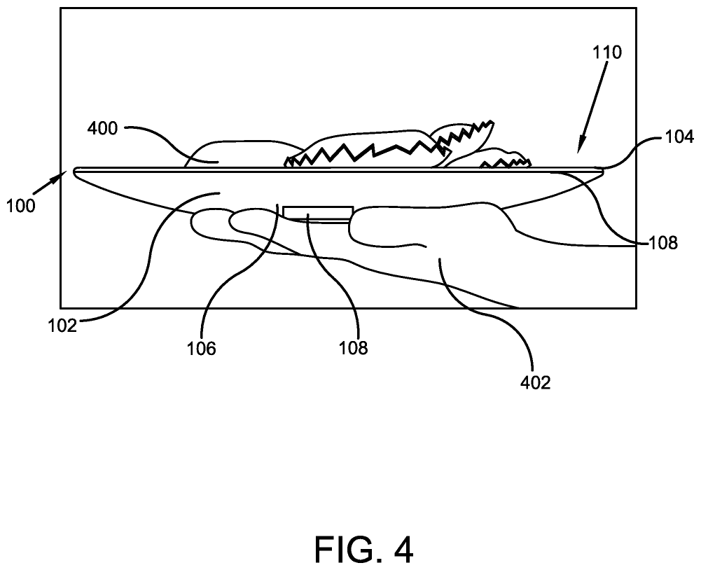

FIG. 4 illustrates a perspective view showing a user carrying a multipurpose plate by holding the rubber or silicone base in accordance with the disclosed architecture. A user can easily hold the warmer plate 100 from the base 106 having the insulated rubber covering 108 using a single hand 402. The insulated rubber covering 108 remains cool even when the embedded heating element 102 radiates heat for keeping the food items 400 placed on the top surface 110 warm and/or hot for consumption. Similarly, the plate 100 can be held using the rim 104 that also includes an insulated rubber covering 108.

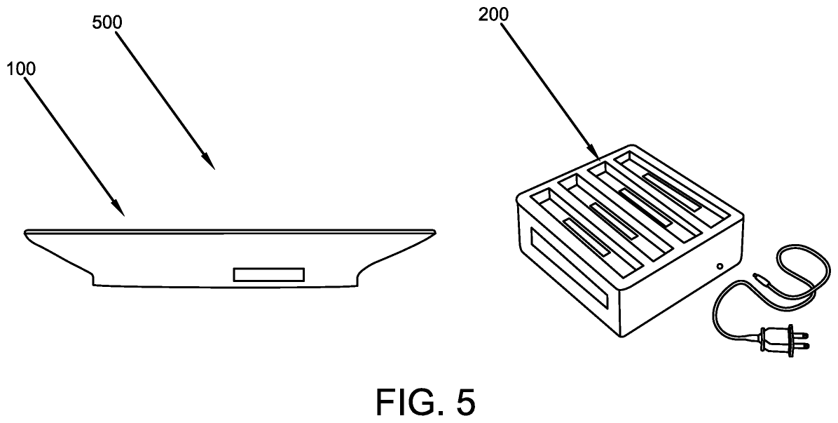

FIG. 5 illustrates a perspective view showing a food warmer kit of the present invention in accordance with the disclosed architecture. The present invention can be commercially embodied as a combination of one or more warmer plates 100 and a charging and storage rack 200. The warmer plates 100 and the charging and storage rack 200 can be of similar design and color. Standalone warmer plates 100 are also available commercially, and can be purchased separately when one of the plates break. The warmer plates 100 can be made up of bone china or fine porcelain with embedded heating elements.

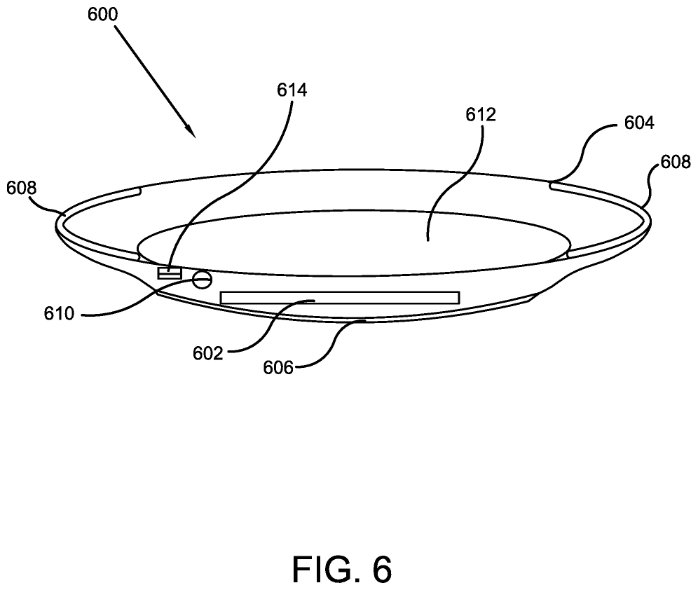

FIG. 6 illustrates a perspective view showing another embodiment of warmer plate of the present invention in accordance with the disclosed architecture. In the present embodiment, the heating element 602 spans across the whole space between the top surface 612 and the insulated bottom surface 606. The rim 604 includes an insulated cover 608 on a portion enabling a user to hold the plate 600 using the insulated rim 608. The charging port 614 can be disposed along the rim 604 where the insulated cover 608 is not present and can be used for charging the heating element 602. A push button 610 is disposed to activate or deactivate the heating element 602 as per the preferences of the user.

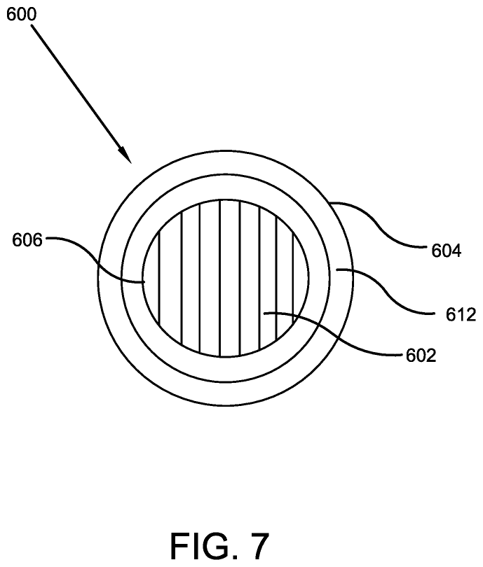

FIG. 7 illustrates a bottom perspective view of another embodiment of the warmer plate of the present invention in accordance with the disclosed architecture. As shown, the heating element 602 spans across the complete space between the bottom surface 606 and the top surface 612. The bottom surface 606 can be insulated with rubber or silicone to remain cool to the touch. The rim 604 can be held by a user enabling easy handling of the plate 600.

The present invention provides a simple, economical and portable warmer plate 100, 600 for thermalizing food and for maintaining the food at a pathogen-free, ready-to-eat temperature without causing deterioration of the food. The plates of the present invention may be stacked in a storage and charging rack 200 for charging. The size of the plates can be made larger or smaller; and may be used in commercial establishments or in the home. The shape of the portable warmer plate 100, 600 can be any geometric shape such as square, rectangular, circular, oval or the like.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “multipurpose plate with integrated heating element”, “multipurpose plate”, “plate”, “warmer plate”, and “multipurpose warmer plates” are interchangeable and refer to the multipurpose plate with integrated heating element 100, 600 of the present invention.

Notwithstanding the forgoing, the multipurpose plate with integrated heating element 100, 600 of the present invention can be of any suitable size and configuration as is known in the art without affecting the overall concept of the invention, provided that it accomplishes the above-stated objectives. One of ordinary skill in the art will appreciate that the size, configuration, and material of the multipurpose plate with integrated heating element 100, 600 as shown in the FIGS. are for illustrative purposes only, and that many other sizes and shapes of the multipurpose plate with integrated heating element 100, 600 are well within the scope of the present disclosure. Although the dimensions of the multipurpose plate with integrated heating element 100, 600 are important design parameters for user convenience, the multipurpose plate with integrated heating element 100, 600 can be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A food warming plate device comprising:
a plate comprising a heat conducting food contact top surface;
an insulated rim portion;
an insulated bottom surface; and
a heating element embedded within the plate and disposed between said heat conducting food contact top surface and said insulated bottom surface, wherein said heating element radiates heat to said heat conducting food contact top surface of said plate.

2. The food warming plate device of claim 1 further comprising a charging port for recharging said heating element.

3. The food warming plate device of claim 2 further comprising a control button for actuating said heating element.

4. The food warming plate device of claim 3, wherein said insulated rim portion comprises a rubber layer.

5. The food warming plate device of claim 3, wherein said insulated rim portion comprises a silicone layer.

6. The food warming plate device of claim 5, wherein said silicone layer is selectively detachable.

7. The food warming plate device of claim 3, wherein said heating element is selected from the group consisting of a heating coil, an electrical resistance plate, and a sheathed electric heating rod.

8. The food warming plate device of claim 7, wherein said heating element comprises a heating range generally from about 120 degrees F. to about 180 degrees F.

9. A food warming plate kit comprising:
a plate comprising a heat conducting food contact top surface;
an insulated rim portion;
an insulated bottom surface;
a heating element embedded within the plate and disposed between said heat conducting food contact top surface and said insulated bottom surface, wherein said heating element radiates heat to said heat conducting food contact top surface; and
a storage and charging rack comprising a plurality of slots for storing a plurality of said plates, wherein each said slot includes a charging port for charging said heating element of said plate.

10. The food warming plate kit of claim 9, wherein said insulated rim portion comprises a rubber layer.

11. The food warming plate kit of claim 9, wherein said insulated rim portion comprises a silicone layer.

12. The food warming plate kit of claim 11, wherein said silicone layer is selectively detachable.

13. The food warming plate kit of claim 9, wherein said heating element is selected from the group consisting of a heating coil, an electrical resistance plate, and a sheathed electric heating rod.

14. The food warming plate kit of claim 13, wherein said heating element comprises a heating range generally from about 120 degrees F. to about 180 degrees F.

15. A food warming plate system comprising:
a plate comprising a heat conducting food contact top surface;
an insulated rim portion;
an insulated bottom surface;
an integrated heating element embedded within the plate and disposed between said heat conducting food contact top surface and said insulated bottom surface, wherein said heating element radiates heat to said heat conducting food contact top surface;
a control button for actuating said heating element from an ON position to an OFF position;
a storage and charging rack comprising a plurality of slots for storing a plurality of said plates, wherein each said slot includes a charging port for charging said heating element of said plate.

16. The food warming plate system of claim 15, wherein said insulated rim portion comprises a silicone layer.

17. The food warming plate system of claim 16, wherein said silicone layer is selectively detachable.

18. The food warming plate system of claim 15, wherein said heating element is selected from the group consisting of a heating coil, an electrical resistance plate, and a sheathed electric heating rod.

19. The food warming plate system of claim 18, wherein said heating element comprises a heating range generally from about 120 degrees F. to about 180 degrees F.

20. The food warming plate system of claim 15 further comprising a battery for powering said charging port for charging said heating element of said plate.
